(19) United States
(12) Patent Application Publication
(10) Pub. No.: US 2019/0197868 A1
(43) Pub. Date: Jun. 27, 2019

(54) Carbon Monoxide Detection, Warning, and Mitigation Assembly

(71) Applicant: Amberlee Guerin, Marcellus, NY (US)

(72) Inventor: Amberlee Guerin, Marcellus, NY (US)

(21) Appl. No.: 15/850,894

(22) Filed: Dec. 21, 2017

(51) Int. Cl. G08B 21/14; F02N 11/10; F02D 17/04; B60K 28/10

(52) U.S. Cl. CPC G08B 21/14; B60K 28/10; F02D 17/04; F02N 11/10

(57) ABSTRACT

A carbon monoxide detection, warning, and mitigation assembly for a vehicle includes a control module, a plurality of bulbs, and a plurality of sensors. The control module is configured to couple to a vehicle and is operationally couplable to an electronic controller of the vehicle. The bulbs and the sensors are configured to couple to an interior surface of the vehicle and are operationally coupled to the control module. The sensors are configured to measure a carbon monoxide level in a passenger compartment of the vehicle and to communicate the carbon monoxide level to the control module. The control module is positioned to compel the bulbs to illuminate and the audio system to emit an audible alert to notify the occupants, and to lower the windows of the vehicle to ventilate the passenger compartment. The control module also is configured to compel the electronic controller to turn off the ignition.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to detection, warning, and mitigation assemblies and more particularly pertains to a new detection, warning, and mitigation assembly for a vehicle.

### BRIEF SUMMARY OF THE INVENTION

An embodiment of the disclosure meets the needs presented above by generally comprising a control module, a plurality of bulbs, and a plurality of sensors. The control module is configured to couple to a vehicle and is operationally couplable to an electronic controller of the vehicle. The bulbs and the sensors are configured to couple to an interior surface of the vehicle and are operationally coupled to the control module. The sensors are configured to measure a carbon monoxide level in a passenger compartment of the vehicle and to communicate the carbon monoxide level to the control module. The control module is positioned to compel the bulbs to illuminate and the audio system to emit an audible alert to notify the occupants, and to lower the windows of the vehicle to ventilate the passenger compartment. The control module also is configured to compel the electronic controller to turn off the ignition.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a carbon monoxide detection, warning, and mitigation assembly according to an embodiment of the disclosure.

FIG. 2 is a side view of an embodiment of the disclosure.

FIG. 3 is a top view of an embodiment of the disclosure.

FIG. 4 is a detail view of an embodiment of the disclosure.

### DETAILED DESCRIPTION OF THE INVENTION

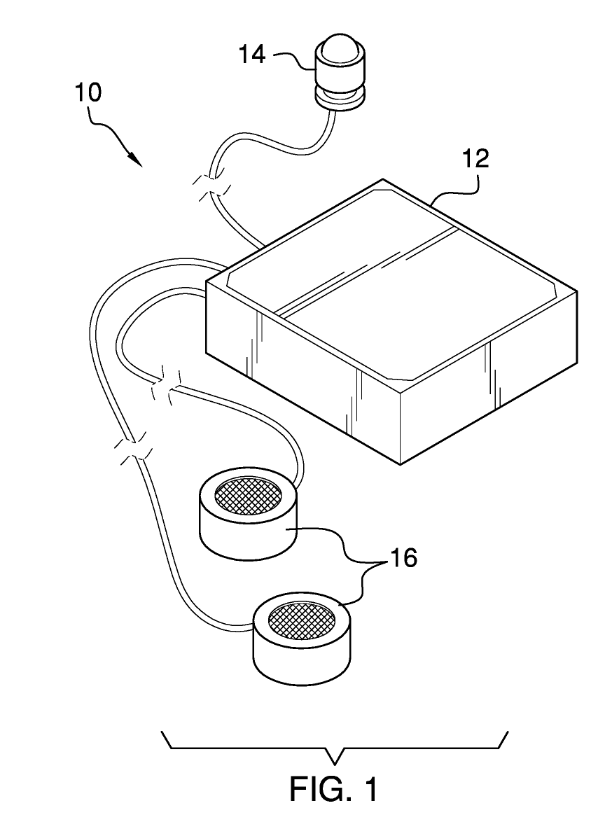

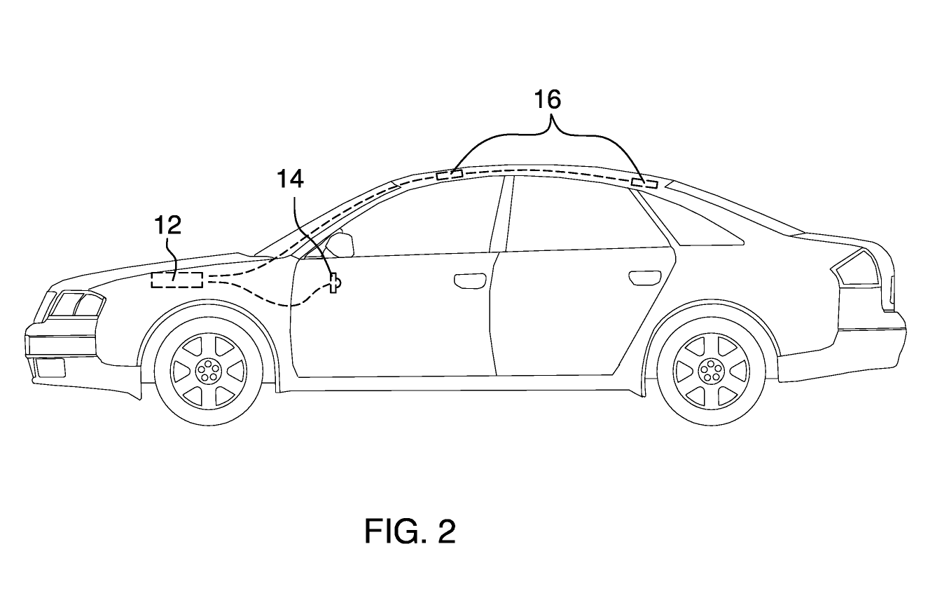

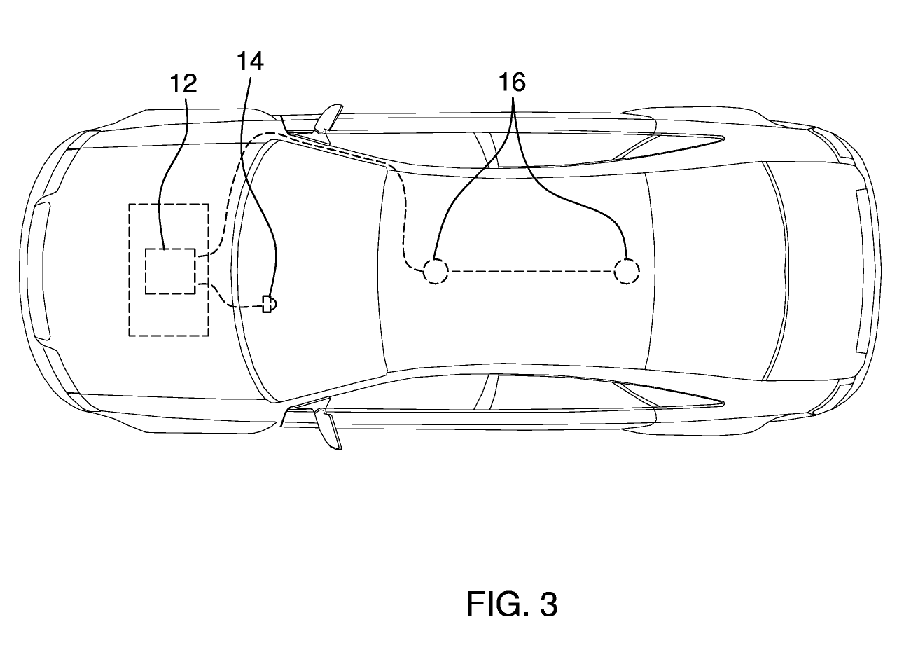

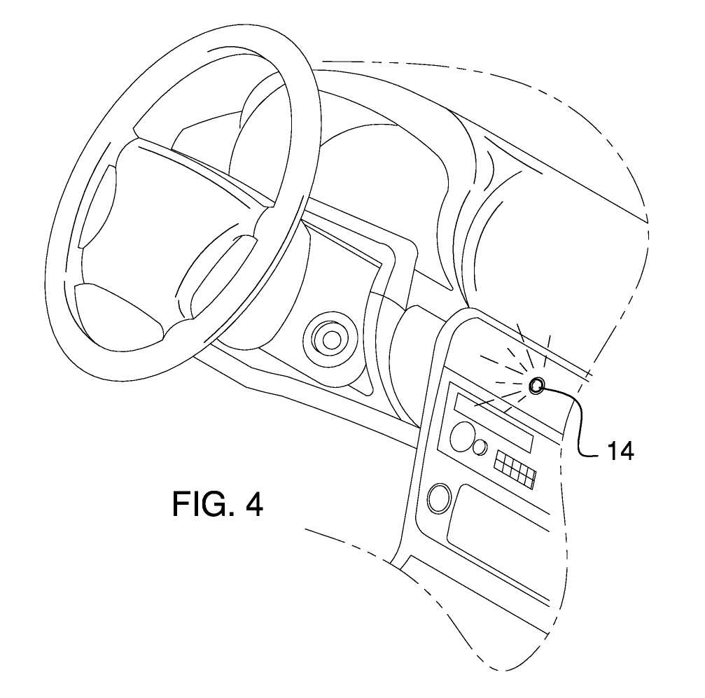

With reference now to the drawings, and in particular to FIGS. 1 through 4 thereof, a new detection, warning, and mitigation assembly embodying the principles and concepts of an embodiment of the disclosure and generally designated by the reference numeral 10 will be described.

As best illustrated in FIGS. 1 through 4, the carbon monoxide detection, warning, and mitigation assembly 10 generally comprises a control module 12 that is configured to couple to a vehicle. The control module 12 is operationally couplable to an electronic controller of the vehicle. The control module 12 is configured to selectively compel the electronic controller to manipulate an audio system, an ignition, and windows of the vehicle. In one embodiment, the control module 12 is configured to position in an engine compartment of the vehicle. In another embodiment, the control module 12 is substantially rectangularly box shaped.

A plurality of bulbs 14 is configured to couple to an interior surface of the vehicle. The bulbs 14 are operationally coupled to the control module 12. In one embodiment, the bulbs 14 emit red light. In another embodiment, the plurality of bulbs 14 comprises one bulb 14 that is configured to position on a dashboard of the vehicle.

A plurality of sensors 16 is configured to couple to the interior surface of the vehicle. The sensors 16 are operationally coupled to the control module 12. The sensors 16 are configured to measure a carbon monoxide level in a passenger compartment of the vehicle and to communicate the carbon monoxide level to the control module 12. In one embodiment, the plurality of sensors 16 comprises two sensors 16. The control module 12 is positioned, in event that the carbon monoxide level exceeds a first threshold level, to compel the bulbs 14 to illuminate to visually alert occupants. The control module 12 is configured, in event that the carbon monoxide level exceeds the first threshold level, to compel the electronic controller to compel the audio system to emit an audible alert to notify the occupants and to lower the windows of the vehicle to ventilate the passenger compartment to lower the carbon monoxide level. The control module 12 is configured, in event that the carbon monoxide level exceeds a second threshold level, to compel the electronic controller to turn off the ignition.

In use, the control module 12 is operationally couplable to the electronic controller of the vehicle so that the control module 12 is configured to selectively compel the electronic controller to manipulate the audio system, the ignition, and the windows of the vehicle. The sensors 16 are configured to measure the carbon monoxide level in the passenger compartment of the vehicle and to communicate the carbon monoxide level to the control module 12. The control module 12 is positioned, in event that the carbon monoxide level exceeds the first threshold level, to compel the bulbs 14 to illuminate to visually alert the occupants. The control module 12 is configured to compel the electronic controller to compel the audio system to emit the audible alert to notify the occupants and to lower the windows of the vehicle to ventilate the passenger compartment to lower the carbon monoxide level. The control module 12 is configured, in event that the carbon monoxide level exceeds the second threshold level, to compel the electronic controller to turn off the ignition.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A carbon monoxide detection, warning, and mitigation assembly comprising:
a control module configured for coupling to a vehicle, said control module being operationally couplable to an electronic controller of the vehicle such that said control module is configured for selectively compelling the electronic controller for manipulating an audio system, an ignition, and windows of the vehicle;
a plurality of bulbs configured for coupling to an interior surface of the vehicle, said bulbs being operationally coupled to said control module;
a plurality of sensors configured for coupling to the interior surface of the vehicle, said sensors being operationally coupled to said control module, said sensors being configured for measuring a carbon monoxide level in a passenger compartment of the vehicle and for communicating the carbon monoxide level to said control module; and
wherein said sensors are positioned in the passenger compartment such that said sensors are configured for measuring the carbon monoxide level in the passenger compartment of the vehicle and for communicating the carbon monoxide level to said control module such that said control module is positioned, in event of the carbon monoxide level exceeding a first threshold level, for compelling said bulbs for illuminating for visually alerting occupants and such that said control module is configured for compelling the electronic controller for compelling the audio system to emit an audible alert for notifying the occupants and for lowering the windows of the vehicle for ventilating the passenger compartment for lowering the carbon monoxide level, and such that said control module is configured, in event of the carbon monoxide level exceeding a second threshold level, for compelling the electronic controller for turning off the ignition.

2. The assembly of claim 1, further including said control module being configured for positioning in an engine compartment of the vehicle.

3. The assembly of claim 1, further including said control module being substantially rectangularly box shaped.

4. The assembly of claim 1, further including said bulbs emitting red light.

5. The assembly of claim 1, further including said plurality of bulbs comprising one said bulb configured for positioning on a dashboard of the vehicle.

6. The assembly of claim 1, further including said plurality of sensors comprising two said sensors.

7. A carbon monoxide detection, warning, and mitigation assembly comprising:
a control module configured for coupling to a vehicle, said control module being operationally couplable to an electronic controller of the vehicle such that said control module is configured for selectively compelling the electronic controller for manipulating an audio system, an ignition, and windows of the vehicle, said control module being configured for positioning in an engine compartment of the vehicle, said control module being substantially rectangularly box shaped;
a plurality of bulbs configured for coupling to an interior surface of the vehicle, said bulbs being operationally coupled to said control module, said bulbs emitting red light, said plurality of bulbs comprising one said bulb configured for positioning on a dashboard of the vehicle;
a plurality of sensors configured for coupling to the interior surface of the vehicle, said sensors being operationally coupled to said control module, said sensors being configured for measuring a carbon monoxide level in a passenger compartment of the vehicle and for communicating the carbon monoxide level to said control module, wherein said sensors are positioned in the passenger compartment such that said sensors are configured for measuring the carbon monoxide level in the passenger compartment of the vehicle and for communicating the carbon monoxide level to said control module such that said control module is positioned, in event of the carbon monoxide level exceeding a first threshold level, for compelling said bulbs for illuminating for visually alerting occupants and such that said control module is configured for compelling the electronic controller for compelling the audio system to emit an audible alert for notifying the occupants and for lowering the windows of the vehicle for ventilating the passenger compartment for lowering the carbon monoxide level, and such that said control module is configured, in event of the carbon monoxide level exceeding a second threshold level, for compelling the electronic controller for turning off the ignition, said plurality of sensors comprising two said sensors; and
wherein said control module is operationally couplable to the electronic controller of the vehicle such that said control module is configured for selectively compelling the electronic controller for manipulating the audio system, the ignition, and the windows of the vehicle, wherein said sensors are positioned in the passenger compartment such that said sensors are configured for measuring the carbon monoxide level in the passenger compartment of the vehicle and for communicating the carbon monoxide level to said control module such that said control module is positioned, in event of the carbon monoxide level exceeding the first threshold level, for compelling said bulbs for illuminating for visually alerting the occupants and such that said control module is configured for compelling the electronic controller for compelling the audio system to emit the audible alert for notifying the occupants and for lowering the windows of the vehicle for ventilating the passenger compartment for lowering the carbon monoxide level, and such that said control module is configured, in event of the carbon monoxide level exceeding the second threshold level, for compelling the electronic controller for turning off the ignition.
